(19) United States
(12) Patent Application Publication
(10) Pub. No.: US 2014/0279485 A1
(43) Pub. Date: Sep. 18, 2014

(54) DROPBOX INTERACTION

(71) Applicant: BANK OF AMERICA CORPORATION, Charlotte, NC (US)

(72) Inventors: Matthew A. Calman, Charlotte, NC (US); Matthew Brian Perkins, Charlotte, NC (US)

(73) Assignee: BANK OF AMERICA CORPORATION, Charlotte, NC (US)

(21) Appl. No.: 13/840,947

(22) Filed: Mar. 15, 2013

(51) Int. Cl. G06Q 40/02

(52) U.S. Cl. CPC G06Q 40/02
USPC 705/42

(57) ABSTRACT

Embodiments of the invention are directed to systems, methods and computer program products for providing an interactive conversation box to a customer of a financial institution. Embodiments initiate presentation, to the customer of the financial institution, of an interface comprising a graphical interactive conversation box; initiate presentation, concurrently with presentation of the conversation box and to the customer of the financial institution, of a graphical element representing a transaction; receive customer selection of the graphical element for inclusion in the conversation box; and initiate presentation, concurrently with presentation of the conversation box and to the customer of the financial institution, of the graphical element or a representation of the graphical element superimposed over the conversation box or presented as part of the conversation box. In some embodiments, the presentation of the conversation box, once initiated, is persistent during presentation of an online banking session.

### BACKGROUND

Typically, when a customer describes a concern to a financial institution, the customer must either type a description of the problem into a chat or email window or talk on a customer service representative over the phone or in person.

### BRIEF SUMMARY

Embodiments of the invention are directed to systems, methods and computer program products for providing an interactive conversation box to a customer of a financial institution.

According to embodiments of the invention, a system includes a memory device storing computer executable code and a processing device to execute the computer executable code to cause the processing device to initiate presentation, to the customer of the financial institution, of an interface comprising a graphical interactive conversation box; initiate presentation, concurrently with presentation of the conversation box and to the customer of the financial institution, of a graphical element representing a transaction; receive customer selection of the graphical element for inclusion in the conversation box; and initiate presentation, concurrently with presentation of the conversation box and to the customer of the financial institution, of the graphical element or a representation of the graphical element superimposed over the conversation box or presented as part of the conversation box.

In some embodiments, the presentation of the conversation box, once initiated, is persistent during presentation of an online banking session.

In some embodiments, the computer executable code is further to cause the processing device to receive customer textual input; and initiate presentation of the customer textual input or a representation of the customer textual input concurrently with presentation of the conversation box, wherein the presentation of the textual input or representation is superimposed over the conversation box or presented as part of the conversation box. In some such embodiments, the computer executable code is further to cause the processing device to analyze the graphical element selected by the customer and the customer's textual input by the customer in order to predict a problem being experienced by the customer and to provide feedback to the customer regarding one or more potential solutions to the problem; and initiate presentation to the customer of a representation of the potential solution.

In some embodiments, the representation of the potential solution is presented concurrently with presentation of the conversation box. In some embodiments, the computer executable code is further to cause the processing device to receive submission of the conversation box; end presentation to the customer of the conversation box; analyze the graphical element selected by the customer and the customer's textual input by the customer in order to predict a problem being experienced by the customer and to provide feedback to the customer regarding one or more potential solutions to the problem; and communicate to the customer one or more potential solutions to the problem. In some embodiments, the computer executable code is further to cause the processing device to receive submission of the conversation box; end presentation to the customer of the conversation box; and attach the submitted conversation box with a record of customer interaction associated with the customer and available for subsequent retrieval.

According to embodiments of the invention, a computer program product is configured for providing an interactive conversation box to a customer of a financial institution, the computer program product comprising a non-transitory computer readable medium having computer executable code stored thereon to cause a processing device to initiate presentation, to the customer of the financial institution, of an interface comprising a graphical interactive conversation box; initiate presentation, concurrently with presentation of the conversation box and to the customer of the financial institution, of a graphical element representing a transaction; receive customer selection of the graphical element for inclusion in the conversation box; and initiate presentation, concurrently with presentation of the conversation box and to the customer of the financial institution, of the graphical element or a representation of the graphical element superimposed over the conversation box or presented as part of the conversation box.

In some embodiments, the presentation of the conversation box, once initiated, is persistent during presentation of an online banking session.

In some embodiments, the computer executable code is further to cause the processing device to receive customer textual input; and initiate presentation of the customer textual input or a representation of the customer textual input concurrently with presentation of the conversation box, wherein the presentation of the textual input or representation is superimposed over the conversation box or presented as part of the conversation box. In some such embodiments, the computer executable code is further to cause the processing device to analyze the graphical element selected by the customer and the customer's textual input by the customer in order to predict a problem being experienced by the customer and to provide feedback to the customer regarding one or more potential solutions to the problem; and initiate presentation to the customer of a representation of the potential solution.

In some embodiments, the representation of the potential solution is presented concurrently with presentation of the conversation box. In some embodiments, the computer executable code is further to cause the processing device to receive submission of the conversation box; end presentation to the customer of the conversation box; analyze the graphical element selected by the customer and the customer's textual input by the customer in order to predict a problem being experienced by the customer and to provide feedback to the customer regarding one or more potential solutions to the problem; and communicate to the customer one or more potential solutions to the problem. In some embodiments, the computer executable code is further to cause the processing device to receive submission of the conversation box; end presentation to the customer of the conversation box; and attach the submitted conversation box with a record of customer interaction associated with the customer and available for subsequent retrieval.

According to embodiments of the invention, a computer-implemented method for providing an interactive conversation box to a customer of a financial institution includes providing a memory device storing computer executable code and a processing device to execute the computer executable code to cause the processing device to initiate presentation, to the customer of the financial institution, of an interface comprising a graphical interactive conversation box; initiate presentation, concurrently with presentation of the conversation box and to the customer of the financial institution, of a graphical element representing a transaction; receive customer selection of the graphical element for inclusion in the conversation box; and initiate presentation, concurrently with presentation of the conversation box and to the customer of the financial institution, of the graphical element or a representation of the graphical element superimposed over the conversation box or presented as part of the conversation box.

In some embodiments, the presentation of the conversation box, once initiated, is persistent during presentation of an online banking session.

In some embodiments, the computer executable code is further to cause the processing device to receive customer textual input; and initiate presentation of the customer textual input or a representation of the customer textual input concurrently with presentation of the conversation box, wherein the presentation of the textual input or representation is superimposed over the conversation box or presented as part of the conversation box. In some such embodiments, the computer executable code is further to cause the processing device to analyze the graphical element selected by the customer and the customer's textual input by the customer in order to predict a problem being experienced by the customer and to provide feedback to the customer regarding one or more potential solutions to the problem; and initiate presentation to the customer of a representation of the potential solution.

In some embodiments, the representation of the potential solution is presented concurrently with presentation of the conversation box. In some embodiments, the computer executable code is further to cause the processing device to receive submission of the conversation box; end presentation to the customer of the conversation box; analyze the graphical element selected by the customer and the customer's textual input by the customer in order to predict a problem being experienced by the customer and to provide feedback to the customer regarding one or more potential solutions to the problem; and communicate to the customer one or more potential solutions to the problem. In some embodiments, the computer executable code is further to cause the processing device to receive submission of the conversation box; end presentation to the customer of the conversation box; and attach the submitted conversation box with a record of customer interaction associated with the customer and available for subsequent retrieval.

### BRIEF DESCRIPTION OF THE DRAWINGS

Having thus described embodiments of the invention in general terms, reference will now be made to the accompanying drawings, where:

FIG. 1 is a block diagram of environment 100, in which systems operate according to embodiments of the invention;

FIG. 2 is a flowchart illustrating a method 200 for providing an interactive conversation box to a customer of a financial institution according to embodiments of the invention;

FIG. 3 is a flowchart illustrating a method 300 for providing an interactive conversation box to a customer of a financial institution according to embodiments of the invention;

FIG. 4 is a flowchart illustrating a method 400 for providing an interactive conversation box to a customer of a financial institution according to embodiments of the invention; and

FIGS. 5-13 are screenshots of an interactive conversation box according to embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

The invention may, in some embodiments provide a pallet, window or dropbox where customers can construct and edit a document that tells the financial institution the story of the customer's problem. The problem may be simple or complex. The dropbox may provide an opportunity to input information on multiple pages or the ability to scroll left and right and/or up and down to increase the drop box “real estate” available for use. The dropbox or conversation box may have a persistent drop zone or dropbox where visual or graphical elements from the customer's user device screen may be selected and dropped (i.e., copied). The invention also, in some embodiments, enables the customer to select some or all other elements from the screen, page, document, webpage, and the like for dragging and dropping into the conversation box. The customer's intention for the conversation box may be to find out “what is this?” element and/or for assembly into a complex message to be considered by the customer service department of the financial institution and/or by an analysis engine of the invention. The invention may provide problem resolution capabilities by analyzing the content of the conversation box, predicting the problem(s) being experienced by the customer and may present potential solution(s) to the customer.

For example, a customer may select (e.g., by clicking, dragging and dropping) a transaction from a list of transactions presented as part of an online banking interface for the conversation box. In some cases, a customer may select multiple transaction from a single account or from multiple accounts and may also edit the conversation box document with text regarding the problem being experienced, one or more of the transactions dropped in the box or otherwise. The customer may also edit the conversation box with pictures, audio/video recording their explanation of the problem and the like. This enables the customer to provide a description of a complex problem or need without requiring articulation of description of every element of the problem (such as a transaction). The conversation box may be shared with a call center or customer service representative or center, shared with the customer and/or the customer's network such as some family and/or friends designated by the customer and may be uploaded to a social network of the customer and/or the financial institution. In some cases, the invention includes analysis of the document in order to remove any personal information from the conversation box before uploading or sending to other individuals and/or networks.

During construction of the document (or after submission of the document, such as to the financial institution call center), the invention may analyze the content of the document to determine that the customer may be able to effectively implement self-help with some instruction from the financial institution. In such situations, the potential solution(s) may be communicated to the customer using the conversation box application or program itself, email, SMS, online banking message, phone call or the like. In this regard, a quick path to self-service resolution may be achieved. Furthermore, one or more financial education topics, links, content and the like may be presented to the customer based on the content and elements the customer is or has included in the conversation box.

The customer-created conversation box may be submitted, stored and routed inside the financial institution, not only to back-end customer service agents, but also to financial institution physical location (i.e., branch) staff who may interact with the customer at another time. The branch and/or personnel to which the conversation box may be communicated may be determined based on the customer's preferences, information, tendencies and the like.

In some embodiments, the invention enables one or more associates of the financial institution to annotate the document and/or attached it to an existing record of the customer's interaction for subsequent retrieval, analysis and/or review. The conversation box document may be saved in the customer's “sent folder” in his or her digital banking communications center, which may be part of the financial institution's online banking functionality.

In various embodiments, the drop zone of the conversation box may be used in conjunction with advertisements and/or offers associated with the financial institution and/or third party(ies). For example, the financial institution may present an offer to a customer for a new bank card if the customer drags and drops the offer into the conversation box to create a document for submission to the financial institution. In this regard, a richer interaction that otherwise may be achieved because the customer has proactively indicated an intent to explore the offer more deeply.

In various embodiments, the content of the conversation box that is visible to the customer may be different than the content that is visible to an associate of the financial institution. For example, a financial institution customer service representative may make additional notes and attach them to the conversation box. In some cases, a conversation box may be stored and accessible by the customer after the conversation box has been submitted for consideration by the financial institution. The customer may only be allowed to view the conversation box that was submitted, whereas another version of the conversation box, or the same version with elements/text hidden from view of the customer may be available to some or all financial institution associates.

In various embodiments, a trail of the customer's activities, such as using the cookies captured by the customer's web browser application, may be used to add additional information to the conversation box (either viewable by the customer or hidden from the customer's view). This information may provide the invention and/or a financial institution associate more information to determine the user's problem(s) and solution(s).

Accordingly, embodiments of the invention are directed to systems, methods and computer program products for providing an interactive conversation box to a customer of a financial institution. Embodiments initiate presentation, to the customer of the financial institution, of an interface comprising a graphical interactive conversation box; initiate presentation, concurrently with presentation of the conversation box and to the customer of the financial institution, of a graphical element representing a transaction; receive customer selection of the graphical element for inclusion in the conversation box; and initiate presentation, concurrently with presentation of the conversation box and to the customer of the financial institution, of the graphical element or a representation of the graphical element superimposed over the conversation box or presented as part of the conversation box. In some embodiments, the presentation of the conversation box, once initiated, is persistent during presentation of an online banking session.

Some embodiments receive customer textual input; and initiate presentation of the customer textual input or a representation of the customer textual input concurrently with presentation of the conversation box, wherein the presentation of the textual input or representation is superimposed over the conversation box or presented as part of the conversation box. Some of these embodiments analyze the graphical element selected by the customer and the customer's textual input by the customer in order to predict a problem being experienced by the customer and to provide feedback to the customer regarding one or more potential solutions to the problem; and initiate presentation to the customer of a representation of the potential solution.

In some embodiments, representation of the potential solution is presented concurrently with presentation of the conversation box. Some embodiments receive submission of the conversation box; end presentation to the customer of the conversation box; analyze the graphical element selected by the customer and the customer's textual input by the customer in order to predict a problem being experienced by the customer and to provide feedback to the customer regarding one or more potential solutions to the problem; and communicate to the customer one or more potential solutions to the problem. Some embodiments receive submission of the conversation box; end presentation to the customer of the conversation box; and attach the submitted conversation box with a record of customer interaction associated with the customer and available for subsequent retrieval.

Referring now to FIG. 1, a block diagram of environment 100, in which systems operate according to embodiments of the present invention is shown. FIG. 1 illustrates an environment 100 in which the financial institution (FI) server 120, the user system 110 and the financial institution customer service representative (FICSR) system 150 interact over a network 102. Each of the systems 120 and 150 communicate over the network 102 with the user system 110. In some embodiments, one or more of the systems 110, 120, and/or 150 communicate directly with one another.

In the various embodiments, the user system 110 is a computer system, mobile device or other computing device used by a client 104 or other user to interact with an organization's servers and/or online content and the like, such as by communicating with the FI server 120 and/or the FICSR system 150. The user system 110 includes, in the embodiment shown, a processing device 112 communicatively coupled with a communication device 114 and a file system 116. The processing device, in some embodiments, is configured for controlling operation of the communication device 114 in order to communicate across the network 102, such as, for example, with the financial institution server 120 and/or the FICSR system 150. The file system 116 is or includes a memory device or other memory configured for storing computer readable instructions 118 such as an operating system, applications, such as a browser and others, other computer program code and the like. In some embodiments, the computer readable instructions include a dropbox program 119 or application configured for instructing the processing device 112 to provide an interactive conversation box to a customer of a financial institution and/or perform one or more of the methods and/or steps discussed herein. The dropbox program 119, in some embodiments, is configured for instructing the processing device 112 to communicate with the FI server, 120 and/or the FICSR system 150 either directly or over one or more external networks. The processing device 112, of course, is configured for accessing and/or retrieving some or all the computer readable instructions 118 and executing some or all of them.

In one embodiment, for example, the network 102 is an intranet or other local area network (LAN) and the user system 110, the third party system 120, and the FICSR system 150 are all part configured for communicating with one another across the intranet. In such an embodiment, the user system 110, when directed by the user 104 to access a particular intranet webpage, uses a browser program to navigate to the intranet webpage. The browser then requests online interaction, such as webpage content, from the FI server 120.

The FI server 120, in some embodiments, is a server such as an organization server. The organization may be a financial institution in some embodiments. In other embodiments, the FI server 120 represents another user's mobile device or other system. In some such cases, the FI server 120 is considered part of one or more backend systems of a bank. The FI server 120 includes, in some embodiments, a processing device 122 communicatively coupled with a communication device 126 and a file system 124, such as a memory device or memory. The processing device 122 is configured for controlling operation of the communication device 126 for communicating over the network 102 such as with the user system 110 and/or the FICSR system 150. The file system 124 is configured for storing computer readable instructions 128, such as, for example, the dropbox program 129, an operating system, other applications, other computer executable program code and the like. The dropbox program 129 includes program code and/or instructions for performing one or more of the methods and/or method steps discussed herein. The processing device 122, of course, is configured to access and/or retrieve some or all the computer readable instructions 128 and execute some or all of them.

The FICSR system 150 is, in some embodiments, a server such as an organization server, a computer system, another computing device or the like. The FICSR system 150, in some embodiments, includes a processing device 152 communicatively coupled with a communication device 154 and a file system 156. The processing device 152 is typically configured to control the communication device for communicating across the network 102 with one or more of the other systems, such as the financial institution server 120 and/or the user system 110. The file system 156 is configured for storing computer readable instructions such as an dropbox program 159, an operating system, other computer executable program code, applications and the like. The processing device 152 is configured for accessing and/or retrieving some or all the computer readable instructions 158 from the file system 156 and executing some or all of them. In some embodiments, for example, the dropbox program 159 includes program code configured to instruct the processing device 152 to communicate with the user device 110 either directly or over one or more external networks.

Further, the embodiments described herein may refer to use of a transaction, transaction event, interaction or interaction event. Unless specifically limited by the context, a “transaction” or “interaction” refers to any communication between the user and a merchant, financial institution, insurance company, or other entity, and the terms “transaction” and “interaction” are used interchangeably herein. A “transaction” or “interaction” may also include a bill, statement, purchase at a POT, online purchase, purchase at a merchant, and/or the like. For example, in some embodiments, a transaction may include one or more of the following: purchasing, renting, leasing, bartering, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like. For example, a transaction may occur when a user purchases a product at a merchant. In yet other embodiments, for example, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-transaction terminal.

In still further embodiments, a transaction may refer to an event and/or action or group of actions facilitated or performed by a user's device, such as a user's mobile system, a merchant system, and/or a combination thereof. A device capable of facilitating or performing a transaction may be referred to herein as a “POT system” or “POT device.” A “point-of-transaction” or “POT” could refer to any location, virtual location or otherwise proximate occurrence of a transaction. A POT system may refer to any device used to perform a transaction, either from the user's perspective, the merchant's perspective or both. In some embodiments, the POT system refers only to a user's system, in other embodiments it refers only to a merchant system, and in yet other embodiments, it refers to both a user device and a merchant device interacting to perform a transaction. For example, in one embodiment, the POT system refers to the user's mobile device configured to communicate with a merchant's system, whereas in other embodiments, the POT system refers to a merchant's system configured to communicate with a user's mobile device, and in yet other embodiments, the POT system refers to both the user's mobile device and the merchant's system configured to communicate with each other to carry out a transaction.

In some embodiments, a POT system is or includes an interactive computer terminal that is configured to initiate, perform, complete, and/or facilitate one or more transactions. A POT system could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a POT system is operated in a public place (e.g., on a street corner, at the doorstep of a private residence, in an open market, at a public rest stop, or the like). In other embodiments, the POT system, is additionally or alternatively operated in a place of business (e.g., in a retail store, post office, banking center, grocery store, factory floor, or the like). In accordance with some embodiments, the POT system is not owned by the user of the POT system. Rather, in some embodiments, the POT system is owned by a mobile business operator or a POT operator (e.g., merchant, vendor, salesperson, or the like). In yet other embodiments, the POT system is owned by the financial institution offering the POT system providing functionality in accordance with embodiments of the invention described herein.

Referring now to FIG. 2, a flowchart illustrates a method 200 for providing an interactive conversation box to a customer of a financial institution according to embodiments of the invention. The first step, represented by block 210, is to initiate presentation of an interface with a graphical interactive conversation box. The conversation box may also be referred to as a dropbox. The presentation is typically provided to a customer of a financial institution who is using a financial institution application on a user device or who is navigating the financial institution website and/or using an authenticated online banking website.

The next step, represented by block 220, is to initiate presentation of a graphical element to the customer. The graphical element may be presented concurrently with presentation of the conversation box and may be or include a transaction or representation of a transaction. A customer may, for example, be logged onto an online banking website and have listing of transactions associated with an account owned by the customer and maintained by the financial institution. The invention may enable the customer to select, such as by clicking and dragging, a single or multiple transactions from the online banking application/window/widget or otherwise and dropping the transaction or a representation of the transaction into or on top of the conversation box. In various embodiments, other types of graphical representations may be selected by the customer and dropping into or on top of the conversation box such as graphics from a website, text from a website, messages received by the user in another application, such as an SMS application, graphics from other applications or websites and the like.

The next step, represented by block 230, is to receive customer selection of the graphical element for inclusion in the conversation box. The next step, represented by block 240, is to initiate presentation of the graphical element (or a representation of the element). This presentation may be superimposed over or as part of the conversation box.

Referring now to FIG. 3, a flowchart illustrates a method 300 for providing an interactive conversation box to a customer of a financial institution according to embodiments of the invention. The first step, represented by block 310, is to receive customer textual input. For example, the customer may have a graphical element dropped into the conversation box and may wish to insert a comment explaining why the user dropped that element into the box. The user may input the desired textual input explaining the user's intention.

The next step, represented by block 320, is to initiate presentation of the customer textual input (or a representation thereof) concurrently with the conversation box. In various embodiments, presentation is superimposed over or as part of the conversation box.

The next step, represented by block 330, is to analyze the graphical element selected by the customer. In some embodiments, the customer's textual input is also analyzed, and in some embodiments, the analysis is combined such that both the graphical element(s) and the textual input(s) of a conversation box are analyzed in conjunction to predict or definitively determine a problem being experienced by the customer. In some cases, the invention correlates the determined or predicted problem with a database coupling problems and solutions and can provide feedback to the customer. The analysis may include searching for keywords and/or key graphics included in the box. This may also include making a determination of a combination of keywords and/or graphical elements and/or portions of graphical elements in the box and correlating the combination with a database of combinations to determine/predict problem(s) and potential solution(s). In some instances, the predicted problem(s) may be communicated to the customer in advance of a potential solution so that the customer may confirm whether the predicted problem is the actual problem, and in other instances, the predicted problem(s) may be communicated concurrently with the potential solution(s). In such cases, the customer may then confirm or deny that the predicted problem(s) is correct and the invention may then, in the case where the customer indicated the predicted problem is incorrect, may predict another problem and present it to the customer for confirmation.

The last step, represented by block 340, is to initiate presentation of a representation of the potential solution to the customer. For example, the potential solution may be presented concurrently with the conversation box and/or communicated to the customer after presentation of the conversation box has ended.

Referring now to FIG. 4, a flowchart illustrates a method 400 for providing an interactive conversation box to a customer of a financial institution according to embodiments of the invention. The first step, represented by block 410 is for the financial institution to receive the customer's submission of the conversation box. The customer may submit the box by selecting a graphical submit button or otherwise. The customer's intention to submit the box may be confirmed before the box is submitted. Submission may refer to the box being forwarded to one or more customer service representatives of the financial institution for consideration, analysis of problem(s), and determination/communication of potential solutions. In other embodiments, the box may be analyzed by the invention as discussed above in order to determine/predict problem(s) and determine potential solution(s) for the customer.

The next step, represented by block 420, is to end presentation of the conversation box. This may be done in response to the customer closing the application and/or website or turning off the user device or otherwise. The next step, represented by block 430, is to analyze the graphical element selected by the customer and/or the customer's textual input to predict a problem being experienced by the customer and provide feedback regarding potential solutions as discussed above. The final step, represented by block 440, is to attach the submitted conversation box (and/or any determined problem(s), solution(s), resolution(s), and the like) with a record of customer interaction associated with the customer so that it may subsequently be retrieved and/or analyzed further.

FIGS. 5-13 are screenshots of an interactive conversation box according to embodiments of the invention. Referring now to FIG. 5, a screenshot 500 of an embodiment of the interactive conversation box is shown. Screenshot 500 shows a widget near the top of the screen for accessing the conversation box from an online banking website of a financial institution.

Referring now to FIG. 6, a screenshot 600 of an embodiment of the interactive conversation box is shown. Screenshot 600 shows an information box that is presented to the customer when the customer selects the widget shown in screenshot 500.

Referring now to FIG. 7, a screenshot 700 of an embodiment of the interactive conversation box is shown. Screenshot 700 shows that when a customer “hovers” or “rolls over” a draggable or selectable item or element on the online banking website, the item or element may be outlined (such as in a specific, recognizable color) and the cursor may change to a hand, thereby indicating the customer's option to “grab” the item or element. As shown, the customer is able to select an offer.

Referring now to FIG. 8, a screenshot 800 of an embodiment of the interactive conversation box is shown. Screenshot 800 shows that the customer may click and drag the selectable item or element in the direction of the arrow to the conversation box widget.

Referring now to FIG. 9, a screenshot 900 of an embodiment of the interactive conversation box is shown. Screenshot 900 shows that the conversation box widget includes an item or element that has been dropped into the conversation box. In this regard, the conversation box widget appearance changes to show it has items in it. In some embodiments, the conversation box widget appearance may further change to indicate it has numerous items in it, that it includes text, or otherwise.

Referring now to FIG. 10, a screenshot 1000 of an embodiment of the interactive conversation box is shown. Screenshot 1000 shows that the customer may continue to build on a conversation by dragging a bank card account into the conversation box.

Referring now to FIG. 11, a screenshot 1100 of an embodiment of the interactive conversation box is shown. Screenshot 1100 shows that the customer may notice a suspicious transaction and add the suspicious transaction to the conversation box.

Referring now to FIG. 12, a screenshot 1200 of an embodiment of the interactive conversation box is shown. Screenshot 1200 shows the conversation box content. The conversation box content may be presented to the customer when the customer selects the widget. In some embodiments, the customer may rearrange and/or delete items or elements from the conversation box. In some embodiments, selecting a “pencil” icon or other icon enables the customer to add a textual note to the item or element or a general note to the conversation box. In some instances, direct links to a specialist may be presented to the customer so that the customer may contact a specialist to discuss over chat, email, phone or otherwise. In some cases, when the customer selects the link to the specialist, items or elements in the conversation box are sent to the specialist for consideration. The customer may also choose to have a specialist contact them, such as by calling them.

Referring now to FIG. 13, a screenshot 1300 of an embodiment of the interactive conversation box is shown. Screenshot 1300 shows that a customer may re-order the items or elements in the conversation box, such as by moving the suspicious transaction to the top of the listing of items.

In various embodiments, one or more of the method steps discussed above may be combined with one or more of the method steps discussed with reference to the same and/or different figures. In various embodiments one or more of the method steps discussed above are not required and are omitted from the method. In various embodiments, one or more of the method steps discussed above may be combined with one or more of the other method steps discussed above and/or one or more additional steps not discussed herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for providing an interactive conversation box to a customer of a financial institution, the system comprising:
a memory device storing computer executable code;
a processing device to execute the computer executable code to cause the processing device to:
initiate presentation, to the customer of the financial institution, of an interface comprising a graphical interactive conversation box;
initiate presentation, concurrently with presentation of the conversation box and to the customer of the financial institution, of a graphical element representing a transaction;
receive customer selection of the graphical element for inclusion in the conversation box; and
initiate presentation, concurrently with presentation of the conversation box and to the customer of the entity, of the graphical element or a representation of the graphical element superimposed over the conversation box or presented as part of the conversation box.

2. The system of claim 1, wherein the presentation of the conversation box, once initiated, is persistent during presentation of an online banking session.

3. The system of claim 1, wherein the computer executable code is further to cause the processing device to:
receive customer textual input; and
initiate presentation of the customer textual input or a representation of the customer textual input concurrently with presentation of the conversation box, wherein the presentation of the textual input or representation is superimposed over the conversation box or presented as part of the conversation box.

4. The system of claim 3, wherein the computer executable code is further to cause the processing device to:
analyze the graphical element selected by the customer and the customer's textual input by the customer in order to predict a problem being experienced by the customer and to provide feedback to the customer regarding one or more potential solutions to the problem; and
initiate presentation to the customer of a representation of the potential solution.

5. The system of claim 1, wherein the representation of the potential solution is presented concurrently with presentation of the conversation box.

6. The system of claim 1, wherein the computer executable code is further to cause the processing device to:
receive submission of the conversation box;
end presentation to the customer of the conversation box;
analyze the graphical element selected by the customer and the customer's textual input by the customer in order to predict a problem being experienced by the customer and to provide feedback to the customer regarding one or more potential solutions to the problem; and
communicate to the customer one or more potential solutions to the problem.

7. The system of claim 1, wherein the computer executable code is further to cause the processing device to:
receive submission of the conversation box;
end presentation to the customer of the conversation box; and
attach the submitted conversation box with a record of customer interaction associated with the customer and available for subsequent retrieval.

8. A computer program product configured for providing an interactive conversation box to a customer of a financial institution, the computer program product comprising a non-transitory computer readable medium having computer executable code stored thereon to cause a processing device to:
initiate presentation, to the customer of the financial institution, of an interface comprising a graphical interactive conversation box;
initiate presentation, concurrently with presentation of the conversation box and to the customer of the financial institution, of a graphical element representing a transaction;
receive customer selection of the graphical element for inclusion in the conversation box; and
initiate presentation, concurrently with presentation of the conversation box and to the customer of the entity, of the graphical element or a representation of the graphical element superimposed over the conversation box or presented as part of the conversation box.

9. The computer program product of claim 8, wherein the presentation of the conversation box, once initiated, is persistent during presentation of an online banking session.

10. The computer program product of claim 8, wherein the computer executable code is further to cause the processing device to:
receive customer textual input; and
initiate presentation of the customer textual input or a representation of the customer textual input concurrently with presentation of the conversation box, wherein the presentation of the textual input or representation is superimposed over the conversation box or presented as part of the conversation box.

11. The computer program product of claim 10, wherein the computer executable code is further to cause the processing device to:
analyze the graphical element selected by the customer and the customer's textual input by the customer in order to predict a problem being experienced by the customer and to provide feedback to the customer regarding one or more potential solutions to the problem; and
initiate presentation to the customer of a representation of the potential solution.

12. The computer program product of claim 8, wherein the representation of the potential solution is presented concurrently with presentation of the conversation box.

13. The computer program product of claim 8, wherein the computer executable code is further to cause the processing device to:
receive submission of the conversation box;
end presentation to the customer of the conversation box;
analyze the graphical element selected by the customer and the customer's textual input by the customer in order to predict a problem being experienced by the customer and to provide feedback to the customer regarding one or more potential solutions to the problem; and
communicate to the customer one or more potential solutions to the problem.

14. The computer program product of claim 8, wherein the computer executable code is further to cause the processing device to:
receive submission of the conversation box;
end presentation to the customer of the conversation box; and
attach the submitted conversation box with a record of customer interaction associated with the customer and available for subsequent retrieval.

15. A computer-implemented method for providing an interactive conversation box to a customer of a financial institution, the method comprising:
providing a memory device storing computer executable code and a processing device to execute the computer executable code to cause the processing device to:
initiate presentation, to the customer of the financial institution, of an interface comprising a graphical interactive conversation box;
initiate presentation, concurrently with presentation of the conversation box and to the customer of the financial institution, of a graphical element representing a transaction;
receive customer selection of the graphical element for inclusion in the conversation box; and
initiate presentation, concurrently with presentation of the conversation box and to the customer of the entity, of the graphical element or a representation of the graphical element superimposed over the conversation box or presented as part of the conversation box.

16. The method of claim 15, wherein the presentation of the conversation box, once initiated, is persistent during presentation of an online banking session.

17. The method of claim 15, wherein the computer executable code is further to cause the processing device to:
receive customer textual input; and
initiate presentation of the customer textual input or a representation of the customer textual input concurrently with presentation of the conversation box, wherein the presentation of the textual input or representation is superimposed over the conversation box or presented as part of the conversation box.

18. The method of claim 17, wherein the computer executable code is further to cause the processing device to:
analyze the graphical element selected by the customer and the customer's textual input by the customer in order to predict a problem being experienced by the customer and to provide feedback to the customer regarding one or more potential solutions to the problem; and
initiate presentation to the customer of a representation of the potential solution.

19. The method of claim 15, wherein the representation of the potential solution is presented concurrently with presentation of the conversation box.

20. The method of claim 15, wherein the computer executable code is further to cause the processing device to:
receive submission of the conversation box;
end presentation to the customer of the conversation box;
analyze the graphical element selected by the customer and the customer's textual input by the customer in order to predict a problem being experienced by the customer and to provide feedback to the customer regarding one or more potential solutions to the problem; and
communicate to the customer one or more potential solutions to the problem.

21. The method of claim 15, wherein the computer executable code is further to cause the processing device to:
receive submission of the conversation box;
end presentation to the customer of the conversation box; and
attach the submitted conversation box with a record of customer interaction associated with the customer and available for subsequent retrieval.
